(19) United States
(12) Patent Application Publication
(10) Pub. No.: US 2018/0200623 A1
(43) Pub. Date: Jul. 19, 2018

(54) SYSTEM AND METHOD FOR CONTROLLING GAME PLAY USING FINGERPRINT RECOGNITION

(71) Applicant: Machine Zone, Inc., Palo Alto, CA (US)

(72) Inventors: Ajk Palikuqi, San Jose, CA (US); Garth Gillespie, Palo Alto, CA (US); Arya Bondarian, Fountain Valley, CA (US); Jai Kim, San Mateo, CA (US)

(21) Appl. No.: 15/837,384

(22) Filed: Dec. 11, 2017

Related U.S. Application Data
(60) Provisional application No. 62/448,108, filed on Jan. 19, 2017.

(51) Int. Cl. A63F 13/426; G06K 9/00; G06F 3/0488; A63F 13/92; A63F 13/2145; A63F 13/215; A63F 13/213; A63F 13/424; A63F 13/218; A63F 13/79

(52) U.S. Cl. CPC A63F 13/426; G06K 9/00087; G06F 3/04883; A63F 13/92; A63F 13/2145; A63F 2300/407; A63F 13/213; A63F 13/424; A63F 13/218; A63F 13/79; A63F 13/215

(57) ABSTRACT

Implementations of the present disclosure are directed to a method, a system, and an article for controlling a multi-player online game using fingerprint recognition. An example method can include: providing a game on a client device having a fingerprint sensor; receiving a user selection of a user action to be implemented in the game upon recognition of a fingerprint; receiving confirmation that the fingerprint has been recognized by the fingerprint sensor; and implementing the user action in the game.

### CROSS-REFERENCE TO RELATED APPLICATIONS

This application claims the benefit of U.S. Provisional Patent Application No. 62/448,108, filed Jan. 19, 2017, the entire contents of which are incorporated by reference herein.

### BACKGROUND

The present disclosure relates to multi-player online games and, in some examples, to systems and methods for using fingerprint identification to control game play for online games.

In general, a multi-player online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players.

In a typical example, a player interacts with the virtual environment by providing input to a user input device. Common user input devices for games can include, for example, a touch screen, a keypad, a joystick, and/or a keyboard. With a touch screen, users can interact with the virtual environment by tapping or selecting items displayed on the screen.

### SUMMARY

In general, the systems and methods described herein allow a user (alternatively referred to herein as a “player”) of a game or other application to provide input using a fingerprint sensor. The user can pre-select certain actions to be taken, for example, when a fingerprint of the user is detected by the fingerprint sensor. The user can associate distinct actions to be taken for each of the user's fingers. In some examples, a pressure sensor is incorporated into the fingerprint sensor and allows the user to provide further input in the form of pressure applied to the pressure sensor. The user can pre-select certain actions to be take according to the pressure.

Advantageously, the approach described herein can greatly simplify the way in which a user can implement one or more actions in the game or other application. For example, use of the fingerprint sensor and/or the pressure sensor can reduce or eliminate the use of menus or other selectable items displayed on a graphical user interface. This can free up space on the graphical user interface and/or provide the user with a complete, unobstructed view of the virtual environment. The complete view can make it easier for the user to monitor the state of the game and respond to any changes. Additionally or alternatively, use of the fingerprint sensor and/or the pressure sensor can make it easier for the user to implement a sequence of actions in the online game. Rather than being forced to scroll through menus and select various options, for example, the user can simply place a finger on the fingerprint sensor and/or apply a desired pressure on the pressure sensor, and the pre-selected actions can be automatically taken. The improved efficiency can make gameplay more enjoyable and can provide users with a competitive advantage over other users.

In one aspect, the subject matter described in this specification relates to a computer-implemented method. The method includes: providing a game on a client device having a fingerprint sensor; receiving a user selection of a user action to be implemented in the game upon recognition of a fingerprint; receiving confirmation that the fingerprint has been recognized by the fingerprint sensor; and implementing the user action in the game.

In certain examples, the fingerprint sensor can include a capacitive sensor. The user action can include at least one interaction with a virtual environment for the game. The at least one interaction can include a sequence of tasks performed in the virtual environment. In some instances, receiving a user selection can include: receiving a user selection of a distinct user action to be implemented in the game upon recognition of each fingerprint from a plurality of fingerprints. The plurality of fingerprints can belong to a single user. The method can include: receiving confirmation that a second fingerprint from the plurality of fingerprints has been recognized by the fingerprint sensor; and implementing a user action corresponding to the second fingerprint in the game.

In various implementations, receiving confirmation that the fingerprint has been recognized can include comparing the fingerprint with a previous fingerprint. The fingerprint sensor can include a pressure sensor, and receiving a user selection can include receiving a user selection of a distinct user action to be implemented in the game upon recognition of the fingerprint and measurement of each pressure from a plurality of pressures. Receiving confirmation that the fingerprint has been recognized can include measuring with the pressure sensor a first pressure from the plurality of pressures, and implementing the user action can include implementing a user action corresponding to the first pressure in the game.

In another aspect, the subject matter described in this specification relates to a system. The system includes one or more computer processors programmed to perform operations including: providing a game on a client device having a fingerprint sensor; receiving a user selection of a user action to be implemented in the game upon recognition of a fingerprint; receiving confirmation that the fingerprint has been recognized by the fingerprint sensor; and implementing the user action in the game.

In certain examples, the fingerprint sensor can include a capacitive sensor. The user action can include at least one interaction with a virtual environment for the game. The at least one interaction can include a sequence of tasks performed in the virtual environment. In some instances, receiving a user selection can include: receiving a user selection of a distinct user action to be implemented in the game upon recognition of each fingerprint from a plurality of fingerprints. The plurality of fingerprints can belong to a single user. The operations can include: receiving confirmation that a second fingerprint from the plurality of fingerprints has been recognized by the fingerprint sensor; and implementing a user action corresponding to the second fingerprint in the game.

In various implementations, receiving confirmation that the fingerprint has been recognized can include comparing the fingerprint with a previous fingerprint. The fingerprint sensor can include a pressure sensor, and receiving a user selection can include receiving a user selection of a distinct user action to be implemented in the game upon recognition of the fingerprint and measurement of each pressure from a plurality of pressures. Receiving confirmation that the fingerprint has been recognized can include measuring with the pressure sensor a first pressure from the plurality of pressures, and implementing the user action can include implementing a user action corresponding to the first pressure in the game.

In another aspect, the subject matter described in this specification relates to an article. The article includes a non-transitory computer-readable medium having instructions stored thereon that, when executed by one or more computer processors, cause the computer processors to perform operations including: providing a game on a client device having a fingerprint sensor; receiving a user selection of a user action to be implemented in the game upon recognition of a fingerprint; receiving confirmation that the fingerprint has been recognized by the fingerprint sensor; and implementing the user action in the game.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for using fingerprint detection to control a multi-player online game.

FIG. 2 is a schematic diagram of an example client device having a fingerprint sensor.

FIG. 3 is a flowchart of an example method of using fingerprint identification to control game play for a game.

### DETAILED DESCRIPTION

In various implementations, the subject matter of this disclosure relates to the use of fingerprint recognition for controlling a game (e.g., a multi-player online game). A user of a client device can provide input to a fingerprint sensor on or in communication with the client device. Upon detection of a fingerprint, certain action, pre-selected by the user, can be taken in a virtual environment for the game. The action can include, for example, a movement of an object (e.g., a character or item), a selection of an object, a use of an object, an interaction with an object, and/or a creation, destruction, or modification of an object. Other types of actions in the virtual environment are possible.

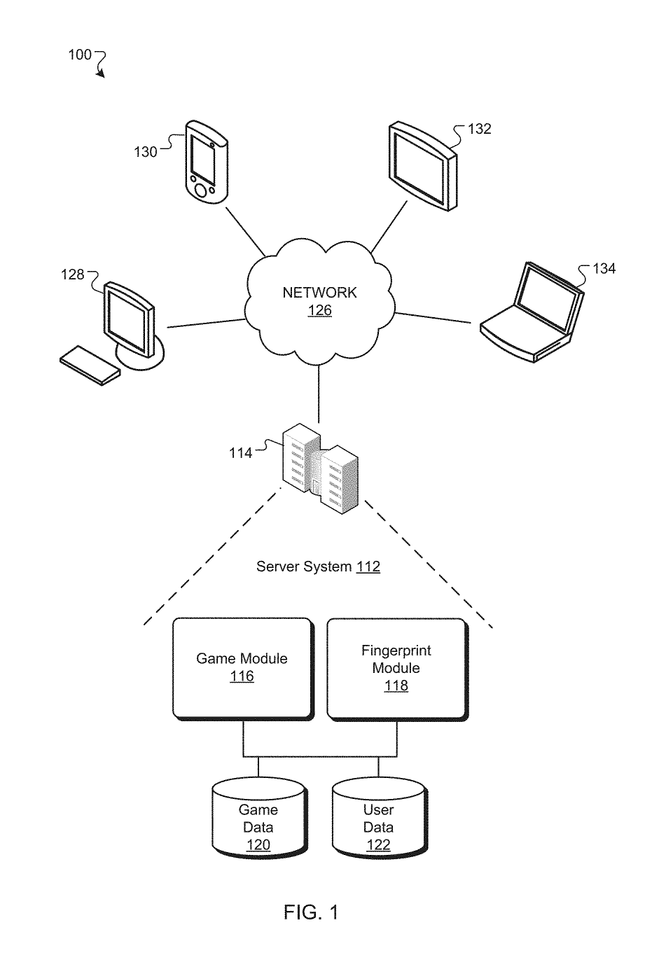

FIG. 1 illustrates an example system 100 for using fingerprint identification to control game play in a multi-player online game. A server system 112 provides functionality for associating player actions with recognized fingerprints and implementing the player actions in the online game. The server system 112 includes software components and databases that can be deployed at one or more data centers 114 in one or more geographic locations, for example. The server system 112 software components can include a game module 116 and a fingerprint module 118. The software components can include subcomponents that can execute on the same or on different individual data processing apparatus. The server system 112 databases can include game data 120 and user data 122 databases. The databases can reside in one or more physical storage systems. The software components and data will be further described below.

An application, such as, for example, a web-based application, can be provided as an end-user application to allow users to interact with the server system 112. The end-user application can be accessed through a network 126 (e.g., the Internet) by users of client devices, such as a personal computer 128, a smart phone 130, a tablet computer 132, and a laptop computer 124. Other client devices are possible. In alternative examples, the game data 120 and/or the user data 122 or any portions thereof can be stored on one or more client devices. Additionally or alternatively, software components for the system 100 (e.g., the game module 116 and/or the fingerprint module 118) or any portions thereof can reside on or be used to perform operations on one or more client devices.

FIG. 1 depicts the game module 116 and the fingerprint module 118 as being able to communicate with the databases (e.g., the game data 120 and the user data 122 databases). The game data 120 database generally includes information related to the multi-player online game implemented using the system 100. The game data 120 database can include, for example, information related to a virtual environment for the game, image, video and/or audio data for the game, event data corresponding to previous, current or future game events, and/or game state data defining a current state of the game. The user data 122 database generally includes data related to user interactions with the online game and/or the virtual environment. Such information can be or include, for example, a history of user connections to the system 100, user purchases, user accomplishments, user tasks, user interactions with other users (e.g., group chats), user virtual item acquisition or usage, and/or other user conditions in the virtual environment and/or real world. The user data 122 database can include information related to user fingerprints and any desired user actions associated with the fingerprints

In various examples, the users or players of the online game can have certain user capabilities in the virtual environment. The user capabilities can be or include, for example, moving an avatar or a virtual item or object to a different geographical location, interacting with characters or other users, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible.

To access these user capabilities, the users can provide input to user input devices on or in communication with the client devices. The user input device for a user can be or include, for example, a touchscreen, a button, a joystick, a keyboard, a keypad, a camera, a microphone, a fingerprint sensor, and a pressure sensor.

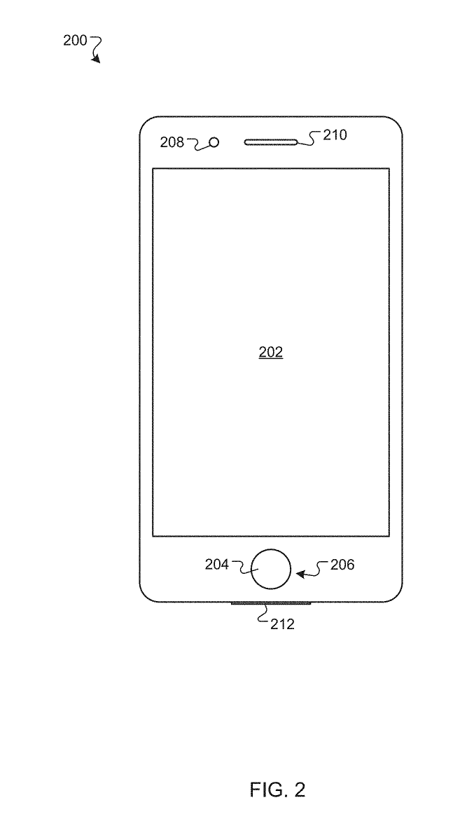

For example, referring to FIG. 2, a client device 200 for the online game can include a touch screen 202, a fingerprint sensor 204, a pressure sensor 206 (e.g., integrated into the fingerprint sensor 204), a camera 208, a speaker 210, and/or a microphone 212. Other input devices are possible. In general, the touch screen 202 can provide a graphical user interface and can display the virtual environment for the user. The user can use the touch screen 202 to interact with the virtual environment, for example, by tapping or selecting displayed items.

The fingerprint sensor 204 can be or include, for example, an optical reader, a capacitive reader, an ultrasound reader, and/or a thermal reader. The fingerprint sensor 204 can measure and recognize fingerprint characteristics (e.g., ridges on the skin) when a finger is placed on the fingerprint sensor 204. The fingerprint module 118 can attempt to match the fingerprint characteristics with one or more previous fingerprints recognized by the fingerprint sensor 204. Matching algorithms used for this purpose can be or include, for example, minutiae matching and/or pattern matching. In certain implementations, the fingerprint module 118 can include or access a fingerprint application programming interface associated with the fingerprint sensor 204 on the client device 200. U.S. Pat. No. 9,117,145, titled “Finger Biometric Sensor Providing Coarse Matching of Ridge Flow Data Using Histograms and Related Methods,” and U.S. Pat. No. 7,359,532, titled “Fingerprint Minutiae Matching Using Scoring Techniques,” describe fingerprint matching methods and are incorporated by reference herein in their entireties.

In certain examples, a user of the client device 200 can program the fingerprint module 118 to take certain actions in the online game (or in other applications) when a fingerprint is recognized by the fingerprint sensor 204. The user can, for example, specify certain user input or action that will be implemented in the online game upon recognition of the user's fingerprint. The specified action can include, for example, a single action or a sequence of multiple actions (e.g., in a specified order). As a simple example, if a user in an online adventure game wants to attack another user, the user can press a finger on the fingerprint sensor 204 to launch the attack. The user can associate recognition of a fingerprint with a pre-selected strategy for the attack, which can involve, for example, deploying specific types and/or quantities of weapons and/or troops. Compared to previous approaches in which the user could be forced to scroll through menus and select various attack options, the fingerprint recognition approach can implement any desired action or sequence of actions with a single user input.

In various implementations, the fingerprint module 118 can be preprogrammed by a user to take a specific action for two or more of the user's fingers. For example, the user could preselect a first set of actions to be taken when a first fingerprint of the user is recognized and a second set of actions to be taken when a second fingerprint of the user is recognized. Further distinct actions could be taken for additional fingers, including each of the user's remaining fingers. This allows the user to take a wide variety of actions in the online game using a single input device. In certain instances, for example, the user could instruct the fingerprint module 118 to take one type of action for each finger on the right hand (e.g., to implement various attack strategies) and a different set of actions for each finger on the left hand (e.g., to implement various defense strategies).

Additionally or alternatively, the user can provide input using the pressure sensor 206, which can be or include, for example, a piezoresistive strain gauge, a capacitive sensor, an electromagnetic sensor, a piezoelectric sensor, an optical sensor, and/or a potentiometric sensor. In general, the pressure sensor 206 can allow the user to control additional or alternative aspects of game actions, events, or series of events, according to a pressure applied by the user to the pressure sensor 206. In some instances, for example, the user can program a certain action to be taken in the game when a fingerprint is recognized and for additional action or variations of an action to be implemented according to the applied pressure. In an adventure game, for example, fingerprint recognition could be used to commence a march of troops in the virtual environment. A corresponding light pressure on the pressure sensor 206 can indicate that the march is to be commenced with a small number of troops, while a heavy pressure on the pressure sensor 206 can indicate that the march is to be commenced with a large number of troops (e.g., most or all of the user's troops). Additionally or alternatively, distinct actions can be taken according to a pressure applied to the pressure sensor 206 after or during the initial fingerprint recognition. In one instance, for example, recognition of the fingerprint can be associated with a first preset action in the game. Recognition of the fingerprint and a subsequent detection of light pressure on the pressure sensor 206 can be associated with a second preset action in the game. Recognition of the fingerprint and subsequent detection of strong pressure on the pressure sensor 206 can be associated with a third preset action in the game. Alternatively, if the pressure sensor 206 is not able to detect different levels of pressure but can determine when the pressure sensor 206 has been pressed (e.g., at more than a threshold pressure value), then recognition of the fingerprint can be associated with one preset action, while recognition of the fingerprint plus detection of a press on the pressure sensor 206 can be associated with another preset action.

In general, the fingerprint module 118 and/or other software components of the system 100 can be programmed to take pre-selected actions in the game (or other application) based on other types of user input. For example, the user can provide instructions to the microphone 212 on the client device 200 that can cause a series of actions or events to be implemented. If the user wants to implement a pre-programmed attack strategy, the user could announce “attack strategy number one” into the microphone 212, and the user's attack strategy number one could be implemented by the system 100. Alternatively or additionally, the system could be programmed to implement the attack strategy when the microphone 212 detects the user tapping a finger on a desk and/or clapping hands in a certain pattern. Additionally or alternatively, the user could provide instructions to implement the attack strategy or other actions by providing input to the camera 208. Such camera input could be or include, for example, waving a hand or fingers in front of the camera 208, or allowing the camera 208 and an associated processor to recognize the user's face or portion thereof. In that case, the user can program the system to take the desired actions when the camera 208 detects a corresponding user input and/or recognizes the user's face or portion thereof or different facial expressions or gestures (e.g., winking, smiling, frowning, or the like). Other types of input can be used and can be associated with one or more specific actions for the game or other application.

In various examples, to program the fingerprint module 118 or other system components, the system 100 can provide a user interface that allows the user to associate specific input with one or more desired actions. The user interface can include, for example, one or more menus that allow the user to specify the input and the associated actions.

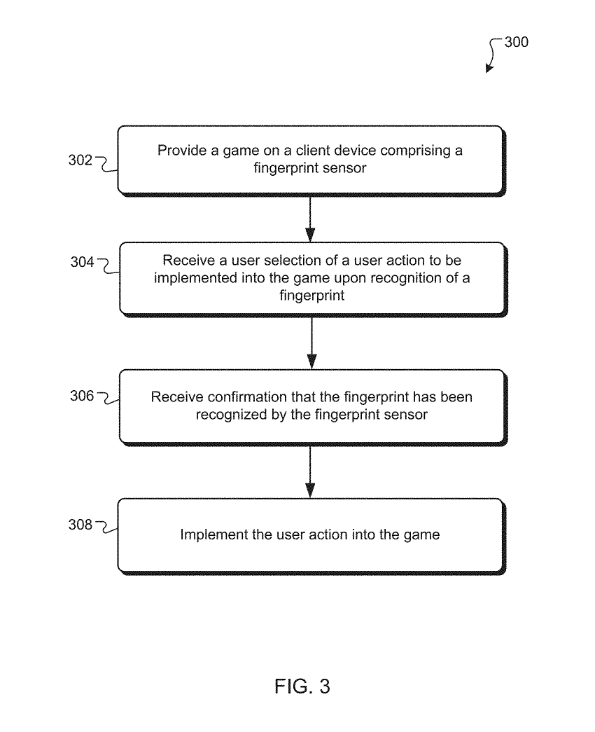

FIG. 3 illustrates an example computer-implemented method 300 of using fingerprint recognition to control a game (e.g., a multi-player online game). A game is provided (step 302) on a client device that includes or is in communication with a fingerprint sensor. A user selection of a user action to be implemented in the game upon recognition of a fingerprint is received (step 304). Confirmation is received (step 306) that the fingerprint has been recognized by the fingerprint sensor. The user action is implemented (step 308) in the game.

Advantageously, the systems and methods described herein can make it easier for a user to provide input to a game or other application and, as a result, can improve overall user experience. In various instances, for example, the approach can free up space on the graphical user interface by avoiding the use of menus or similar displayed selectable features. Such menus can occupy significant space on the graphical user interface and/or can block the display of the virtual environment. By providing the fingerprint sensor and/or the pressure sensor, the user can have an unobstructed view of the virtual environment and can more easily monitor the state of the game. This can make it easier for the user to make decisions in the game and/or respond to any changes. Additionally or alternatively, the fingerprint recognition approach can make it easier for the user to implement a sequence of actions quickly, which can give the user a competitive advantage over other users. With conventional approaches, for example, it could take a user 5-10 seconds to implement a defense strategy when the user is being attacked by another user. With the fingerprint approach, however, the user can implement the defense strategy in about one second or less. The time savings can result in a more favorable outcome for the user.

The use of fingerprint recognition also provides security, particularly when a client device is accessible to more than one user. For example, a user's pre-programmed actions can be uniquely tied to recognition of the user's fingerprint. This can prevent other users from accessing, exploiting, or gaining an unfair advantage from the pre-programmed actions.

Uses of the fingerprint module 118, the fingerprint sensor 204, and/or the pressure sensor 206 can be extended to other applications (e.g., outside of gaming). In a social network application, for example, a user could program the fingerprint module 118 to open certain selected user profiles when a fingerprint is recognized. This can make it easier for the user to access user profiles for people the user is following in the social network.

Additionally or alternatively, in an email or file management application, the fingerprint module 118 can be programmed to select or open specific folders or files when a fingerprint is recognized. For example, if the user wants to move to an Inbox or other specific mail folder, the user could apply a finger to the fingerprint sensor 204 and the desired mail folder could be automatically accessed or opened upon fingerprint recognition.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method comprising:
providing a game on a client device comprising a fingerprint sensor;
receiving a user selection of a user action to be implemented in the game upon recognition of a fingerprint;
receiving confirmation that the fingerprint has been recognized by the fingerprint sensor; and
implementing the user action in the game.

2. The method of claim 1, wherein the fingerprint sensor comprises a capacitive sensor.

3. The method of claim 1, wherein the user action comprises at least one interaction with a virtual environment for the game.

4. The method of claim 3, wherein the at least one interaction comprises a sequence of tasks performed in the virtual environment.

5. The method of claim 1, wherein receiving a user selection comprises:
receiving a user selection of a distinct user action to be implemented in the game upon recognition of each fingerprint from a plurality of fingerprints.

6. The method of claim 5, wherein the plurality of fingerprints belong to a single user.

7. The method of claim 5, further comprising:
receiving confirmation that a second fingerprint from the plurality of fingerprints has been recognized by the fingerprint sensor; and
implementing a user action corresponding to the second fingerprint in the game.

8. The method of claim 1, wherein receiving confirmation that the fingerprint has been recognized comprises comparing the fingerprint with a previous fingerprint.

9. The method of claim 1, wherein the fingerprint sensor comprises a pressure sensor, and wherein receiving a user selection comprises:
receiving a user selection of a distinct user action to be implemented in the game upon recognition of the fingerprint and measurement of each pressure from a plurality of pressures.

10. The method of claim 9, wherein receiving confirmation that the fingerprint has been recognized comprises measuring with the pressure sensor a first pressure from the plurality of pressures, and wherein implementing the user action comprises implementing a user action corresponding to the first pressure in the game.

11. A system, comprising:
one or more computer processors programmed to perform operations comprising:
providing a game on a client device comprising a fingerprint sensor;
receiving a user selection of a user action to be implemented in the game upon recognition of a fingerprint;
receiving confirmation that the fingerprint has been recognized by the fingerprint sensor; and
implementing the user action in the game.

12. The system of claim 11, wherein the fingerprint sensor comprises a capacitive sensor.

13. The system of claim 11, wherein the user action comprises at least one interaction with a virtual environment for the game.

14. The system of claim 13, wherein the at least one interaction comprises a sequence of tasks performed in the virtual environment.

15. The system of claim 11, wherein receiving a user selection comprises:
receiving a user selection of a distinct user action to be implemented in the game upon recognition of each fingerprint from a plurality of fingerprints.

16. The system of claim 15, wherein the plurality of fingerprints belong to a single user.

17. The system of claim 15, the operations further comprising:
receiving confirmation that a second fingerprint from the plurality of fingerprints has been recognized by the fingerprint sensor; and
implementing a user action corresponding to the second fingerprint in the game.

18. The system of claim 11, wherein receiving confirmation that the fingerprint has been recognized comprises comparing the fingerprint with a previous fingerprint.

19. The system of claim 11, wherein the fingerprint sensor comprises a pressure sensor, and wherein receiving a user selection comprises:
receiving a user selection of a distinct user action to be implemented in the game upon recognition of the fingerprint and measurement of each pressure from a plurality of pressures.

20. An article, comprising:
a non-transitory computer-readable medium having instructions stored thereon that, when executed by one or more computer processors, cause the computer processors to perform operations comprising:
providing a game on a client device comprising a fingerprint sensor;
receiving a user selection of a user action to be implemented in the game upon recognition of a fingerprint;
receiving confirmation that the fingerprint has been recognized by the fingerprint sensor; and
implementing the user action in the game.
